(19) United States
(12) Patent Application Publication
(10) Pub. No.: US 2015/0017967 A1
(43) Pub. Date: Jan. 15, 2015

(54) METHOD AND APPARATUS FOR DETERMINING A PREDICTED DURATION OF A CONTEXT

(71) Applicants: Huanhuan Cao, Beijing (CN); Jilei Tian, Beijing (CN); Heikki Waris, Helsinki (FI)

(72) Inventors: Huanhuan Cao, Beijing (CN); Jilei Tian, Beijing (CN); Heikki Waris, Helsinki (FI)

(73) Assignee: Nokia Corporation, Espoo (FI)

(21) Appl. No.: 14/371,052

(22) PCT Filed: Jan. 17, 2012
(86) PCT No.: PCT/CN2012/070472

§ 371 Date: Jul. 8, 2014

(51) Int. Cl. H04W 8/22

(52) U.S. Cl. CPC H04W 8/22
USPC 455/418

(57) ABSTRACT

An approach is provided for determining a predicted duration of a context. A context duration platform causes, at least in part, a determination, a prediction, or a combination thereof of one or more contexts associated with at least one device. The context duration platform further processes and/or facilitates a processing of context information associated with the at least one device, other context information associated with one or more other devices, or a combination thereof to determine one or more predicted durations of the one or more contexts.

### BACKGROUND

Service providers and device manufacturers (e.g., wireless, cellular, etc.) are continually challenged to deliver value and convenience to consumers by, for example, providing compelling network services. Service providers and device manufacturers continue to provide services and devices that take advantage of and collect context information associated with devices to provide a more personalized experience for users based on various contexts. However, the determination of the contexts requires the continuous collection of context information. Further, as the collection of context information to determine the current context of devices becomes more prevalent, service providers are attempting to determine future contexts of the devices to attempt to configure and/or personalize future services based on the predicted future contexts. Although attempting to predict the future contexts of devices may lead to more personalized future services, in actuality, merely predicting the future contexts, alone, amounts to nothing more than predicting the current context based on past context information. In other words, predicting the future context still requires the continuous collection of context information to continuously determine the future context. Such continuous collection of context information based mainly on the devices collecting the context information poses a significant strain on, for example, the resources of the devices. Accordingly, service providers and device manufacturers face significant technical challenges is developing a method to determine the contexts of device without continuously monitoring or collecting context information.

### SOME EXAMPLE EMBODIMENTS

Therefore, there is a need for an approach for predicting a duration of a context.

According to one embodiment, a method comprises causing, at least in part, a determination, a prediction, or a combination thereof of one or more contexts associated with at least one device. The method also comprises a processing of context information associated with the at least one device, other context information associated with one or more other devices, or a combination thereof to determine one or more predicted durations of the one or more contexts.

According to another embodiment, an apparatus comprises at least one processor, and at least one memory including computer program code for one or more computer programs, the at least one memory and the computer program code configured to, with the at least one processor, cause, at least in part, the apparatus to determine, predict, or a combination thereof of one or more contexts associated with at least one device. The apparatus is also caused to process context information associated with the at least one device, other context information associated with one or more other devices, or a combination thereof to determine one or more predicted durations of the one or more contexts.

According to another embodiment, a computer-readable storage medium carries one or more sequences of one or more instructions which, when executed by one or more processors, cause, at least in part, an apparatus to determine, predict, or a combination thereof of one or more contexts associated with at least one device. The apparatus is also caused to process context information associated with the at least one device, other context information associated with one or more other devices, or a combination thereof to determine one or more predicted durations of the one or more contexts.

According to another embodiment, an apparatus comprises means for causing, at least in part, a determination, a prediction, or a combination thereof of one or more contexts associated with at least one device. The apparatus also comprises means for processing of context information associated with the at least one device, other context information associated with one or more other devices, or a combination thereof to determine one or more predicted durations of the one or more contexts.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of originally filed claims 1-10, 21-30, and 36-38.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of determining a predicted duration of a context, according to one embodiment;

FIG. 2 is a diagram of the components of a context duration platform, according to one embodiment;

FIG. 3 is a flowchart of a process for determining a predicted duration of a context, according to one embodiment;

FIG. 4 is a flowchart of a process for determining context information for determining a predicted duration of a context, according to one embodiment;

FIG. 5 is a flowchart of a process for determining a predicted duration of a context based on subsequent other context information from one or more other devices, according to one embodiment;

FIG. 6 is a flowchart of a process for testing the predicted durations, according to one embodiment;

FIG. 7 is a flowchart of a process for adapting one or more prediction models to determine a predicted duration, according to one embodiment;

FIGS. 8A-8C are diagrams of user interfaces utilized in the processes of FIGS. 3-7, according to various embodiments;

FIG. 9 is a diagram of hardware that can be used to implement an embodiment of the invention;

FIG. 10 is a diagram of a chip set that can be used to implement an embodiment of the invention; and

FIG. 11 is a diagram of a mobile terminal (e.g., handset) that can be used to implement an embodiment of the invention.

### DESCRIPTION OF SOME EMBODIMENTS

Examples of a method, apparatus, and computer program for determining a predicted duration of a context are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

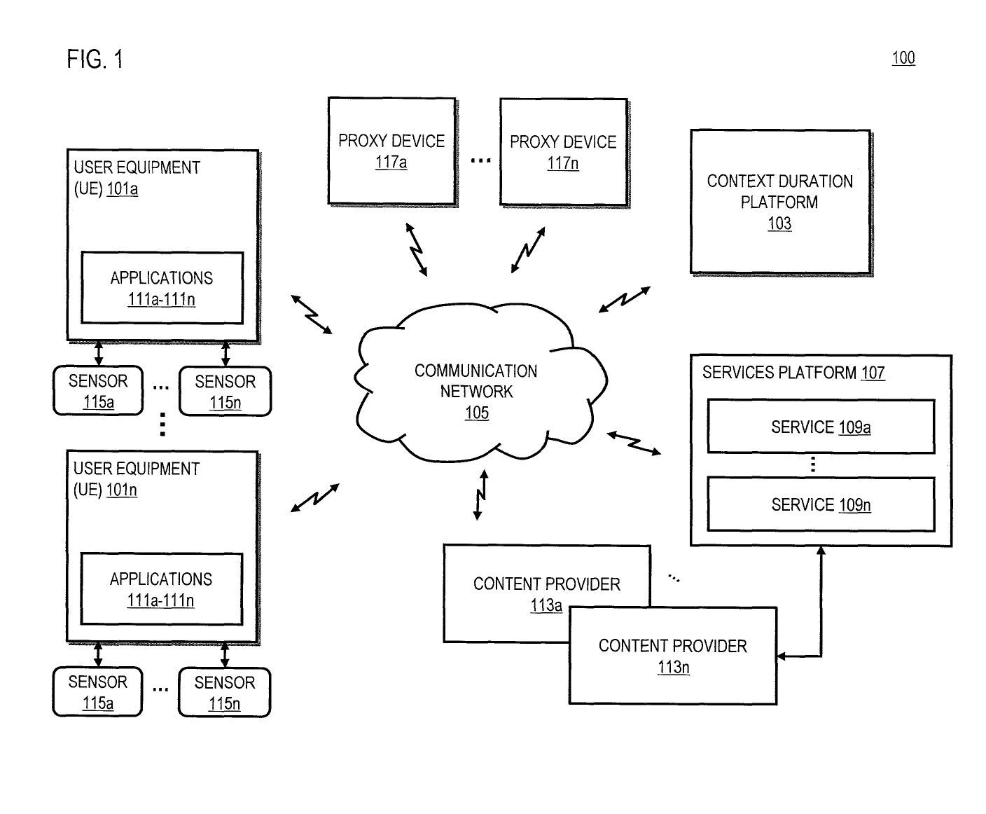

FIG. 1 is a diagram of a system capable of determining a predicted duration of a context, according to one embodiment. As discussed above, service providers and device manufacturers have developed services and devices that collect and process context information associated with devices as a way to personalize users' experiences with the devices. The collection of context information allows service providers and device manufacturers to determine the current context of the device, and even the current context of the user of the device. By understanding the current context of the device, service providers can provide personalized services based on the current context. By way of example, devices can determine their context, such as location, and pass the location information to services, such as weather services, that can then provide information regarding the location, such as the current weather. Services can also collect context information, such as browser history, to provide more personalized experiences with respect to users browsing websites using their devices.

Context information may be regarded as streaming information, particularly when the context of time is considered. Context information may be continuously generated as time passes, and as the context of a user changes and/or remains the same. For example, as the context of a user based on location changes and/or remains the same, the context is represented by a stream of context information. The stream of context information may be segmented based on the various contexts, such as when the context remains the same according to, for example, a location over a period of time. The context segment may be defined based on the duration over which the location remained the same. Thus, information regarding the context may be obtained based on the duration of the segment. If the duration is long, the context may be associated with a home or place of business (e.g., extended periods at the same location associated with sleeping at home or working at a place of business). Durations of a set interval at a certain location may represent, for example, a cinema or a house of worship where the user regularly visits for a set duration (e.g., length of a movie or length of a religious service). Thus, the duration may help define the context.

In addition to providing a more personalized experience, the collection and processing of context information also allows for a more automated experience for the user. For example, rather than requiring that a user enters the name or zip code of the closest city to retrieve weather information associated with the city, the device can automatically determine its location using location based services (e.g., GPS) and retrieve the weather information using the determined location.

Further, one area of interest with respect to context information for service providers and device manufacturers is the prediction of future contexts of the devices and/or users. Being able to predict the future contexts of devices would allow service providers to provide more personalized and predictive services based on the predicted contexts.

However, one issue related to determining the context of a device, with respect to both the present context and the future context, is that the determination requires the collection and processing of context information. Whether a service provider is providing services based on the current context or a future context, the service provider must receive and process context information associated with the device. For example, to determine the current location of a device, a service provider must receive some form of location information associated with the device. To determine the future location of the device, the service provider must receive some form of location information and, for example, some additional location information to predict the future location of the device. Thus, in both examples, context information is required to determine or predict the location. In such a scenario, to continuously determine or predict the current or future location of the device, context information must be continuously collected. This requires devices to continuously collect context information through, for example, one or more sensors that may consume large amounts of resources of a device. Although device manufacturers are developing more powerful devices with additional resources for handling additional and more complex process, such as collecting context information, the continued demand for context information for even powerful devices depletes the resources.

Further, current collection of context information relies heavily on the device to collect the context information. For example, to determine the current location of the device, the device may interface with a global positioning system. Although the global positioning system aids the devices in determining the location, the device is the primary source for the request and determination of location. The focus on the device for collecting the context information not only depletes the resources of the device, but also ignores other systems and approaches for determining context information associated with the device.

To address these problems, a system 100 of FIG. 1 introduces the capability to determine a predicted duration of a context associated with a device and/or a user of the device. By determining a predicted duration of a context, context information is not required for the remainder of the duration to be able to determine the context. Rather, the context remains the same for the predicted duration. The system 100 causes a determination, a prediction, or a combination thereof of one or more contexts associated with a device. Further, the system 100 processes context information associated with the device, other context information associated with one or more other devices, or a combination thereof to determine one or more predicted durations of the one or more contexts. By determining the one or more predicted durations, the system 100 introduces the capability to determine and/or predict a context of a device and a predicted duration of the context such that, for example, the continual collection and processing of context information to determine the current or predicted context of the device is not required. Rather, the current or predicted context of the device may be determined based on, for example, the collection of context information, and a subsequent collection and processing of context information may not be required for up to, or at least, the predicted duration.

By way of example, a user associated with a device may be associated with a specific location. Such a specific location may be, for example, the location associated with the user's place of work. Based on context information collected from the user's device, which indicates the user is at the user's place of work during normal business hours based on both current context information (e.g., current location and current time) and historical context information (e.g., previous time patterns associated with the user's place of work), the system 100 may determine a predicted duration associated with the duration the user will stay at the specific location. Such an exemplary use may be defined as, for example, a stay point, where the user will stay at the current specific location (e.g., point) for a predicted duration. The duration may be based on, for example, the amount of time left between the current time and the end of normal business hours (e.g., determined from previous time patterns at the current location) as determined by the system 100. In which case, the system 100 can determine the user's location and a predicted duration associated with the location such that, for example, the system 100 does not need to determine the user's location by requesting context information from the user's device for the remainder of the duration.

Based on the predicted durations of the contexts, the system 100 introduces the capability for service optimization and configuration. The system 100 introduces the capability to cause a scheduling of one or more functions, one or more services, or a combination thereof associated with the device. The scheduling of the one or more functions and/or the one or more services allows, for example, for an optimal scheduling of functionality and services associated with the device based on the determined or predicted contexts. By way of example, where a determined or predicted context is predicted to have a duration of two hours, and the context is associated with a specific location, rather than the device subsequently determining the location based on a location service (e.g., GPS), the device can instead determine that the location will remain the same for the predicted duration and not interface with a location service. By doing so, the device can save the resources for other tasks that would otherwise be required to determine the location. By way of another example, the system 100 allows for the optimization of, for example, a service package associated with a device. Depending on the predicted duration associated with a context of, for example, a location, the system 100 may optimize the provisioning of the service package associated with the device. If the service package is large but the device is associated with a context that provides for a fast connection between the service package provider and the device (e.g., WiFi), the system 100 may provide for a provisioning of the service package if the predicted duration associated with the location is sufficient for the provisioning. If the predicted duration is not sufficient, the system 100 may provide for a segmentation of the service package into one or more smaller packages of which one or more may be provisioned to the device during the predicted duration. Such optimization may occur by, for example, providing information associated with the duration to the service package provider so that the provider may modify the service package to be compatible with the restraints of the predicted duration.

The system 100 also introduces the capability to collect context information of a device through one or more other devices (e.g., a proxy device) that are associated with the device through one or more interactions. One or more identifiers associated with the device or with a user that is associated with the device may be used to link the interactions with the device. The device may be associated with context information that is associated with the interaction, the one or more other devices, or a combination thereof based on the identification of the interaction using the one or more identifiers. The context information may be in the form one or more attributes. The attributes may be determined based on a semantic analysis of the one or more interactions and/or the one or more other devices. Additionally, context information associated with the device may subsequently be associated with the one or more other devices and used to determine or refine the one or more attributes associated with the one or more other devices.

In one embodiment, where there is no context information, or insufficient context information associated with a device for which a predicted duration is being determined, the system 100 introduces the capability to determine the predicted duration based on a semantic analysis of the current context information, or based on the other context information associated with one or more other devices according to a crowd sourcing approach. The semantic analysis may be based on the type of the current context. For example, where the predicted duration is based on the current location of a device, a semantic analysis may be performed to determine whether the current location is associated with a point of interest, or associated with a popular location or associated with a landmark. With respect to an analysis based on the location, the analysis could be based on any other geographical information. With respect to the one or more other devices, the system 100 introduces the capability to determine the predicted duration of a determined or predicted context based on the known behavior of other devices. For example, for a determination of the duration of the context of riding on a train, if other context information indicates that other devices are primarily on the train until reaching an specific endpoint along the route (e.g., the main trains station), the system 100 may predict that the duration of the context of riding on the train is the expected duration of the train ride until the final destination is reached.

In one embodiment, the system 100 uses one or more prediction models to determine the predicted duration of a context. One or more of the prediction models may be based on context information. The context information is collected and processed as training data for the one or more prediction models. By way of example, the context information is transformed into a sequence of training samples (y, x) with a time interval T, where y denotes whether the user stayed in the same place in T time and x denotes the context information of the user, such as location information, time information, and other context information captured by the user's device. The sequence information is used to generate a model F that can infer y given x according to the function y=F(x). Such a function can be solved using various approaches, such as, for example, Support Vector Machine (SVM), Naïve Bayes, Decision tree, etc. In one embodiment, context information is collected at a device and sent to one or more other devices (e.g., servers) for processing to determine the one or more prediction models. In one embodiment, the context information may be collected at the device and transferred to another device (e.g., a personal computer) once a direct connection between the devices is established. Then, the other device may process the information to determine the one or more prediction models. Additionally, the context information may be determined at the device and processed at the device to generate one or more prediction models.

Based on the complexity of the prediction models used, different models may be used in different situations. For example, given an in-device training approach, SVM may not be applicable because of the high complexity and limited computing resources of mobile devices. However, the SVM approach may be used where the collected context information is uploaded to a backend server or device with additional resources (e.g., a personal computer) for training the model and subsequently downloaded back to the device. Other approaches may be acceptable for in-device training were the approaches are less complicated, or where there is a hybrid approach such that a portion of the model is trained at a backend or desktop computer, and a remainder of the model is trained at the device.

In one embodiment, the system 100 introduces the capability to adapt the prediction models for determining the predicted duration. For cold start cases (e.g., cases where there is no or little context information), the prediction models may be adapted as context information is collected over time and as the predicted durations are tested by collecting subsequent context information.

As shown in FIG. 1, the system 100 comprises a user equipment (UE) 101a-101n (collectively referred to as UE 101) having connectivity to a context duration platform 103 via a communication network 105. The UE 101 may include, or be associated with, one or more applications 111a-111n (collectively referred to as applications 111). The applications 111 may determine and/or process context information associated with the UE 101 and/or a user of the UE 101. The applications 111 may include, for example, one or more social networking applications, navigation applications, calendar applications, daily/weekly/monthly planning applications, appointment applications, mapping applications, browser applications, etc. that may be associated with various types of context information, such as location information, temporal information, browser information, appointment information, etc. The applications 111 can determine and/or process context information associated with the UE 101 to determine or predict the contexts of the UE 101, as well as predicted durations of the contexts. In one embodiment, one or more applications 111 at the UE 101 may perform one or more functions associated with determining a predicted duration of a context associated with the UE 101. By way of example, one or more applications 111 may include one or more prediction models that process context information associated with the device, context information associated with one or more other devices, or a combination thereof to determine the contexts and/or predicted durations of the contexts. One or more applications may also interface with one or more proxy devices 117a-117n (collectively referred to as proxy devices 117) (e.g., a server, a desktop computer, one or more other UE 101, etc.) to interface with, at least in part, one or more prediction models associated with the proxy devices 117 to determine a predicted duration of a context.

Associated with the UE 101 are one or more sensors 115a-115n (collectively referred to as sensors 115). The sensors 115 may collect various types of context information, such as location information, movement information (e.g., acceleration, velocity, etc.), light information, climate conditions, etc. Thus, in combination with, or independent of, the applications 111, the sensors 115 can determine context information associated with the UE 101 to determine or predict the contexts of the UE 101, as well as predicted durations of the contexts.

The system 100 also comprises a services platform 107 that includes one or more services 109a-109n (collectively referred to as services 109) and content providers 113a-113n (collectively referred to as content providers 113). The services 109 may include any type of service, such as social networking services, navigational services, computational services, recommendation services, appointment services, planning services, etc. One or more of the services 109 may also include one or more prediction models for predicting a duration of a context associated with the UE 101. In one embodiment, the functions performed by the context duration platform 103 may be embodied in whole, or in part, by one or more services 109. The content providers 113 may provide content to the UE 101, the context duration platform 103, the services platform 107 (e.g., the services 109) and the proxy devices 117. The content provided may be associated with content used by one or more applications 111 and/or one or more services 109.

The proxy devices 117 may be one or more other devices that are associated with other context information that may be used to determine and/or predict the context of a UE 101, as well as determine one or more predicted durations of the one or more contexts. By way of example, the one or more proxy devices 117 may include an automatic teller machine (ATM) that detects usage by a user based on the user's identity being linked to a debit card associated with the bank that provides the ATM. Accordingly, the ATM can provide other context information associated with the interaction, such as the time, location and amount of the transaction. The proxy devices 117 may also be one or more other devices that include one or more prediction models that may embody the functions of the context duration platform 103 that determine the one or more predicted durations of the contexts. By way of example, a proxy device 117a may be a server that collects the context information associated with the device to generate one or more prediction models that determine predicted durations of contexts, which are then forwarded back to the UE 101. The proxy device 117a may also be a desktop computer that the user directly connects to her UE 101 that downloads context information upon detecting the connection to, at least in part, generate one or more prediction models that are then uploaded to the UE 101 for determining predicted durations of contexts based on context information.

By way of example, the communication network 105 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, near field communication (NFC), Internet Protocol (IP) data casting, digital radio/television broadcasting, satellite, mobile ad-hoc network (MANET), and the like, or any combination thereof.

The UE 101 is any type of mobile terminal, fixed terminal, or portable terminal including a mobile handset, station, unit, device, mobile communication device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UE 101 can support any type of interface to the user (such as “wearable” circuitry, etc.).

The context duration platform 103 introduces the capability to collect context information of UE 101 through one or more other devices (e.g., a proxy devices 117, one or more other UE 101, etc.) that are associated with the UE 101 through one or more interactions and/or through a crowd sourcing approach. The one or more other devices may be associated with one or more systems. By way of example, one or more other devices may be a ticket vending machine for purchasing a bus ticket that is associated with a bus system, or cash register at a department store that is associated with the department store's merchandise system. One or more identifiers associated with the UE 101, or with a user that is associated with the UE 101, may be used to link the interactions to the UE 101. By way of example, one or more identifications may include a credit or debit card number used in a transaction, a special savings card used in a transaction, a club member's card used to access a club, etc. To maintain security and/or privacy, the identifiers may be provided as transforms such as hashes. One or more identifiers may include biometric data, such as audio samples, images, or molecular sensor readings). In one embodiment, an identification of a user may be based on, for example, a combination of image and audio recognition. The UE 101 may be associated with context information that is associated with the interaction, the one or more other devices, or a combination thereof based on the identification of the interaction associated with the UE 101 using the one or more identifiers. The context information may be in the form one or more attributes. The attributes may be determined based on an analysis of the one or more interactions and/or the one or more other devices. Additionally, context information associated with the UE 101 may subsequently be reciprocally associated with the one or more other devices and used to determine and/or refine the one or more attributes associated with the one or more other devices.

By way of example, a user associated with a UE 101a that is compatible with near field communications (NFC) uses the NFC capabilities of the UE 101a to purchase a train ticket from a ticket vending machine (e.g., a proxy device 117a). An application 111a on the UE 101a associated with the transaction includes an identification number that identifies the specific UE 101a used in making the transaction, which is linked to a bank account to debit money for the transaction. The ticket vending machine may be associated with the context duration platform 103 to forward context information to the context duration platform 103 regarding devices that interact with the ticket vending machine. The context information may include, for example, the interaction itself, and implicitly that the UE 101a was in the vicinity of the ticket vending machine, the amount of the transaction, the train the ticket was bought for, the route of the train, the origin and destination stations, etc. Based on this context information, the context duration platform 103 may determine one or more predicted durations of one or more contexts associated with the UE 101a. For example, if the train ride will last for two hours, the context duration platform 103 can determine the predicted duration for the context of riding on the train is two hours.

Based on this predicted duration, functionality and services associated with the UE 101a may be managed or scheduled to, for example, minimize resource consumption of the UE 101a and improve resource efficiency. For example, determination of the specific location of the UE 101a may instead be determined based on interfacing with a service 109a that provides information associated with the specific train that the ticket was purchased for rather than interfacing with the UE 101a. Moreover, general location (e.g., train headed to Chicago) may be determined by the context duration platform 103 alone based on the information initially provided as a result of the transaction. The context duration platform 103 may then provide the location information to any one of other UE 101, proxy devices 117 and/or service providers 109 (e.g., updating a social networking site regarding the location of the user and/or UE 101a). Further, by determining the context information associated with the UE 101a through the system associated with the ticket vending machine (e.g., proxy device 117a), the context information is not directly obtained from the UE 101a and thus conserves energy of the UE 101a while still providing context information.

In one embodiment, although context information associated with the UE 101a is determined based on the interaction with the proxy device 117a, the context duration platform 103 may request from the UE 101a additional context information. By way of example, if a waiter takes an order using a proxy device 117a, the context duration platform 103 may instruct the UE 101a to report the signal strength of a nearby wireless local area network (WLAN) to determine the exact location within the restaurant associated with a user.

Similarly, the UE 101a may be associated with the context duration platform 103 to forward context information to the context duration platform regarding the context information associated with the UE 101a. The context information may include, for example, the resources of the UE 101a, historical information associated with the UE 101a, such as where the UE 101a was prior to making the transaction, browser history associated with the UE 101a, etc. This information may be used to determine one or more attributes associated with the proxy device 117a (e.g., the ticket vending machine). The service provider associated with the proxy device 117a may then use the context information from the UE 101a to determine information, such as marketing information based on the habits of users and their associated devices that purchase tickets using the proxy device 117a. This reciprocal exchange of information provides an incentive for service providers associated with proxy devices 117 to interface with the context duration platform 103 to provide context information to the context duration platform 103 for determining predicted durations of contexts associated with devices that interact with the proxy devices 117. In one embodiment, the context duration platform 103 may determine context information associated with the UE 101a for any type of context information that is currently missing for a given type of transaction of a specific proxy device 117 or context information that is outdated or potentially outdated (e.g., not updated based on a threshold). Upon updating context information, if the updated context information does not match previously acquired context information, the context duration platform 103 may increase requests associated with the specific context information that does not match to verify the change. In one embodiment, the context duration platform 103 will weight the context information received from the UE 101 based on one or more parameters associated with the context information. By way of example, where context information varies based on time, the context duration platform 103 may weight the context information that is closest to the point in time associated with the interaction between the proxy device 117a and the UE 101a the highest as compared to other context information. Further, context information that varies from that time may be weighted less than context information that does not vary.

In one embodiment, the context duration platform 103 may individually identify proxy devices 117 through a semi-unique proxy device 117 identifier and collected interaction information that includes a user identity. By way of example, two or more proxy devices 117 that are associated with interactions with one or more UE 101 may be indistinguishable based solely on the device identifiers (e.g., identical model numbers). However, the two or more proxy devices 117 may vary according to some form of context information, such as location. Thus, if a user performs an interaction with one proxy device 117a such that the proxy device 117a reports the identifier associated with the user to the context duration platform 103. The context duration platform 103 may then request the most recent cell identification of the UE 101a associated with the user. Based on the cell identification, the context duration platform 103 may determine which one of the proxy devices 117 is the correct proxy device 117a that interacted with the UE 101a. The same process may be performed if two identifiers associated with two different users and/or UE 101 are not unique.

In one embodiment, the context duration platform 103 determines one or more types of interactions. The context duration platform 103 further processes the one or more types of the one or more interactions to determine one or more impacts to the one or more contexts. The context duration platform 103 further determines the one or more predicted durations based on the one or more impacts. The context duration platform 103 may further cause an association of the one or more impacts with the one or more proxy devices (e.g., other devices) associated with the interactions as at least one attribute of the one or more proxy devices.

By way of example, a user may purchase a bus ticket using a credit card. Based on the credit card system informing the context duration platform 103 of the transaction, the context duration platform 103 may be informed of the user purchasing the ticket. The type of interaction may be defined as, for example, a trip. The context duration platform 103 subsequently determines the impact of the transaction based on the information provided by the credit card system, or based on the bus ticketing system. The impact may be the duration of the bus ticket that was purchased. Accordingly, based on the detected duration (e.g., impact), the context duration platform 103 may determine a predicted duration of the context of riding the bus. In one embodiment, the context duration platform 103 may assign the impact of, for example, the duration of the average bus ticket purchased from the bus ticket system as an attribute of the system.

In one embodiment, the context duration platform 103 determines subsequent other context information associated with the one or more other devices. The subsequent other context information is context information that is generated by the one or more other devices after the one or more interactions. The context duration platform 103 then processes the subsequent other context information to determine the one or more predicted durations of the one or more contexts, the one or more impacts, or a combination thereof.

In one embodiment, the system 100 uses one or more prediction models to determine the predicted duration of a context. One or more of the prediction models may be based on context information. The context information is collected and processed to use as training data for the one or more prediction models. By way of example, the context information is transformed into a sequence of training samples (y, x) with a time interval T, where y denotes whether the user stayed in the same place in T time and x denotes the context information of the user, such as location information, time information, and other context information captured by the user's device. The sequence information is used to generate a model F that can infer y given x according to the function y=F(x). Such a function can be solved using various approaches, such as, for example, Support Vector Machine (SVM), Naïve Bayes, Decision tree, etc. Based on the complexity of the prediction models used, different models may be used in different situations. For example, given an in-device training approach, SVM may not be applicable because of the high complexity and limited computing resources of mobile devices. However, the SVM approach may be used where the collected context information is uploaded to a backend server or device with additional resources (e.g., a desktop computer) for training the model and subsequently downloaded back to the device. Other approaches may be acceptable for in-device training were the approaches are less complicated, or where there is a hybrid approach such that a portion of the model is trained at a backend or desktop computer, and a remainder of the model is trained at the device. In one embodiment, the system 100 introduces the capability to adapt the prediction models for determining the predicted duration. For cold start cases (e.g., cases where there is no or little context information), the prediction models may be adapted as context information is collected over time and as the predicted durations are tested by collecting context information to test the predicted durations. Thus, the prediction models may be updated.

In one embodiment, the context duration platform 103 includes one or more prediction models that are used to determine one or more predicted durations of one or more contexts. As discussed above, the context duration platform 103 may adapt the one or more prediction models as more context information is collected to train the prediction models. The context duration platform 103 may also train the prediction models as more context information is collected subsequent to predictions of the durations. Thus, in one embodiment, the context duration platform 103 causes a comparison of one or more actual durations of one or more contexts against one or more predicted durations of the one or more contexts. The context duration platform 103 further causes an update of one or more of the prediction models based on the comparison.

By way of example, the context duration platform 103 may determine a predicted duration associated with a context of a UE 101a, such as the predicted duration associated with a specific location. In one embodiment, upon the predicted duration expiring, or prior to the predicted duration expiring, the context duration platform 103 may determine the current location of the UE 101a. The current location may or may not match the location associated with the predicted duration. Based on whether the actual location matches the location associated with the predicted duration, the context duration platform 103 may adapt the one or more prediction models in accordance with the comparison. For example, if the current location does not match the context associated with the predicted duration, the context duration platform 103 may determine to shorten the predicted duration in the future based on similar context information as the context information used to determine the predicted duration. In one embodiment, the context duration platform 103 may periodically determine the location of the UE 101a during the predicted duration to monitor when, if ever, the location of the UE 101a changes to a location (e.g., context) other than the location associated with the predicted location. If and when the location changes within the predicted duration, the time at which the change approximately occurred may be used to update the one or more prediction models.

In one embodiment, the context duration platform 103 causes a generation of one or more test conditions for execution by the UE 101, one or more other devices (e.g., other UE 101 and/or proxy devices 117), or a combination thereof. The one or more test conditions facilitate a determination of one or more transitions from one or more contexts to one or more other contexts. The context duration platform 103 further determines the one or more impacts based on the one or more transitions.

By way of example, the UE 101, the context duration platform 103, the services platform 107, the content providers 113 and the proxy devices 115 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

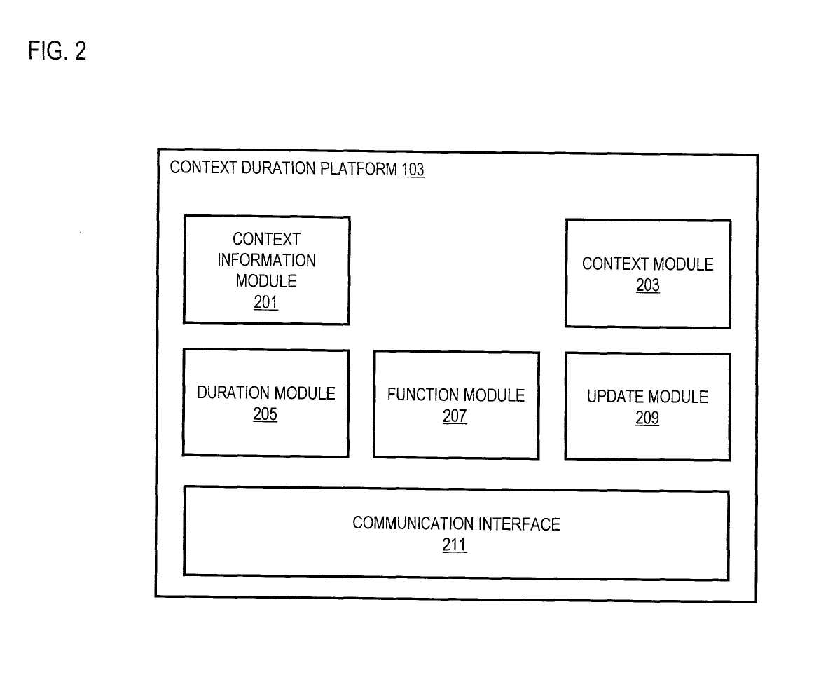

FIG. 2 is a diagram of the components of a context duration platform 103 according to one embodiment. By way of example, the context duration platform 103 includes one or more components for determining a predicted duration of a context. It is contemplated that the functions of these components may be combined in one or more components or performed by other components of equivalent functionality. By way of example, one or more of the functions of the context duration platform 103 may be performed by one or more applications 111 at the UE 101, one or more services 109 at the services platform 107 and/or one or more proxy devices 117. In this embodiment, the context duration platform 103 includes a context information module 201, a context module 203, a duration module 205, a function module 207, an update module 209 and a communication interface 211.

The context information module 201 interfaces with the various components of the system 100 through the communication interface 211 to determine the context information associated with the UE 101 and/or the proxy devices 117. With respect to the UE 101, the context information module 201 may interface with one or more of the applications 111 and/or sensors 115 associated with the UE 101 to determine the context information of the UE 101. As discussed above, the context information may be any type of information that may be processed to determine the context of the UE 101, such as location information, acceleration information, velocity information, functionality information, connectivity information (e.g., network connectivity), etc. The context information module 201 may also interface with one or more of the services 109 and the proxy devices 117 to determine context information associated with the UE 101. The context information associated with the proxy devices 117 may be associated with the UE 101 when the UE 101 have one or more interactions with the proxy devices 117 based on the type of interaction. By way of example, certain interactions between proxy devices 117 and UE 101 require the UE 101 to be in the same location as the proxy devices 117. Thus, the context information associated with the location of the proxy devices 117 also applies to the UE 101. The context information may include any other information that defines or is associated with the interaction and with a type of the interaction. For example, if the interaction is a transaction, the context information may include goods exchanged with the interaction, the price of the transaction, the date and time of the transaction, etc. Similarly, when the context duration platform 103 interfaces with one or more proxy devices 117 to assign context information and/or one or more attributes to the proxy devices 117 based on interactions with one or more UE 101, the context information module 201 assigns the context information and/or attributes to the proxy devices 117. As discussed above, the context information of the UE 101 may be processed to determine one or more impacts associated with the proxy devices 117 that are subsequently associated as attributes of the one or more proxy devices 117. For example, an impact may be such that, after an interaction with a proxy device 117a, a UE 101a stays in the same location for approximately three hours. This impact may be correlated to the proxy device 117a as an attribute of the proxy device 117a. The context duration platform 103 may subsequently use the attribute of the proxy device 117a in determining one or more predicted durations.

The context module 203 determines and/or predicts one or more contexts associated with the UE 101 and/or the proxy devices 117. The context module 203 may process context information associated with the UE 101 and/or the proxy devices 117 to determine the contexts of the UE 101 and the proxy devices 117. The context module 203 may determine the context of the UE 101, such as the current context of the UE 101, and also may predict the context of the UE 101, such as the future context of the UE 101. Based on context information of the UE 101, other UE 101, or one or more proxy devices 117, the context module 203 may predict the context of the UE 101. By way of example, if the context information associated with a proxy device 117a indicates that the user associated with a UE 101a purchased a train ticket and the ticket indicates that the train leaves in two hours, the context module 203 may determine the future context of the UE 101a associated with the user, such as being on the train starting in two hours. By way of another example, if an identifier associated with a user (e.g., a credit card number) indicates that the user purchased a parking ticket for two hours, the context module 203 can determine that the current context of the user and the associated UE 101a is at the parking garage. The context module 203 may further predict the context of a UE 101a based on historical context information associated with the UE 101a. The context module 203 may determine certain behaviors or patterns in the context information associated with the UE 101a that indicate future or predicted contexts. By way of example, if a user that visits a certain location usually visits another location immediately after visiting the first location, the context module 203 may predict the future context of the user according to the other location that is historically visited after visiting the first location.

If the user does not have enough historical context information associated with specific context information (e.g., associated with a certain location or activity), the context module 203 may use other context information associated with one or more other UE 101 to predict the context of the user. By way of example, if other users associated with other UE 101 that visit location A tend to then visit location B, when the context duration platform 103 determines context information associated with the user indicating the user is at location A, the context module 203 may predict that the user will then visit location B. Thus, the context module 203 may predict the context of the user will be location B in the future. Similarly, if a user associated with a UE 101a interacts with a proxy device 117a, such as a cash register at a restaurant paying for a meal, the context duration platform 103 may receive context information associated with the UE 101a based on the transaction. The context module 203 may determine the context of the UE 101a based on the context information, such as currently at the restaurant. In one embodiment, based on one or more interactions between a UE 101a and one or more other UE 101 and/or proxy devices 117, the context module 203 also may determine the past context of the UE 101a. With respect to the example above, the UE 101a may have not provided context information to the context duration platform 103 while the user was enjoying her meal at the restaurant; perhaps the last three hours if the meal was for a special occasion. Upon the context duration platform 103 receiving the context information associated with the transaction of the user paying for her meal, the context module 203 may determine that the user was at the restaurant for the past three hours based on, for example, historical context information and/or context information from one or more other users associated with other UE 101. Thus, the context module 203 may fill in holes with respect to the context of the user, such as where the UE 101a associated with a user is not continuously providing context information to the context duration platform 103.

The duration module 205 processes context information associated with a device (e.g., UE 101a), other context information associated with one or more other devices (e.g., one or more other UE 101, one or more proxy devices 117, other components of the system 100), or a combination thereof to determine one or more predicted durations of the contexts determined by the context module 203. The context information of the device may be historical context information that is used to train one or more prediction models based on the habits of the user of the device. By way of example, certain context information may indicate that a user will have a certain context for a certain duration according to prediction models. Accordingly, when the context module 203 determines the certain context, the duration module 205 may determine the duration of the context based on the previous durations of the contexts. The other context information of one or more other devices UE 101 may by the historical context information of other users that is used to train one or more prediction models based on the habits of the other users. Similar to the above example, other context information may indicate that one or more other users will have a certain context for a certain duration. When the context module 203 determines the certain context for the user, the duration module 205 may determine the duration of the user based on the past durations of the other users. The other context information of the one or more other devices may also be context information associated with one or more interactions between the user associated with the device and one or more other devices (e.g., proxy devices 117). The proxy devices 117 may be associated with various types of interactions that are associated with various impacts to the contexts of users associated with the interactions. The impacts may be used to determine the predicted durations of the contexts. The impacts may be associated with temporal information, such as a length of time, transition information, such as a transition from one context to another context (e.g., from one location to another location). The impacts may further be associated with a lack of a transition, such as remaining at the same context.

By way of example, a user may use a credit card to pay for a transaction at a retailer, such as a grocery store. The credit card includes information that links the user to the transaction. The information may be transmitted to the context duration platform 103 and collected by the context information module 201. The information may also include the total amount paid for the transaction, which implies, for example, the amount of groceries that the user bought. Using this information, the context module 203 may determine that the user is on the way home to put away the groceries (e.g., the context). The duration module 205 may predict the duration of the context based on, for example, the time the user normally takes to go home from the grocery store.

In another example, the user may purchase a concert ticket. The concert ticket may be for a concert at a specified date in the future and for a specified duration. The context module 203 may predict the context of the user during the specific date (e.g., at the concert) and the duration module 205 may predict the duration of the context (e.g., the length of the concert). In one embodiment, the duration module 205 may determine context information associated with other users (e.g., other UE 101) that have attended similar concerts in the past to determine the actual durations of the users at the previous concerts. Thus, although the concert length may be set by, for example, the concert venue, the duration module 205 may determine a predicted duration of the context based on past behaviors of other users that attended similar concerts. Rather than determining the predicted duration being the duration of the concert set by the concert venue, the predicted duration may instead be based on the average duration of other users that have attended the concert.

In one embodiment, the duration module 205 determines a predicted duration that is a span of time. The duration may have a predicted start time, a predicted end time, or a combination thereof. By way of example, the duration module 205 may determine a predicted duration associated with a context that starts immediately and ends after two hours. Thus, the duration is two hours, the start time is the current time, and the end time is either explicitly determined or implicitly determined based on the duration. In one embodiment, the start time of the duration may be unknown, but the length of the duration may be known. By way of example, the context module 203 may predict a context associated with a UE 101. The duration module 205 may further determine a predicted duration associated with the context. However, the start time of the context may be unknown. The context duration platform 103 may predict that a user will arrive at a location (e.g., the context), and may remain at the location for a certain period of time (e.g., the predicted duration), but may not know the point in time that the user will arrive at the location. However, upon determining that the user arrived at the location, the start time of the predicted duration is then known and the predicted duration begins to lapse.

In one embodiment, the context duration platform 103 may include a function module 207. The function module 207 interfaces with the context module 203 and the duration module 205 to schedule functionality and services at the UE 101 based on the contexts and predicted durations of the contexts of the UE 101. The function module 207 controls the functionality of the UE 101 based on the predicted durations to provide more optimal resource optimization. By way of example, if a determined context of a UE 101a is a location that includes a high speed WLAN, and the predicted duration of the context an hour, the function module 207 may schedule the UE 101a to download updates for one or more applications 111 on the UE 101 that would otherwise take considerable resources to download if the UE 101a were instead associated with a cellular network.

The function module 207 may also interface with one or more services 109 to perform one or more functions and or services on behalf of one or more UE 101. By way of example, if the context duration platform 103 determines the context of a UE 101 and predicts the duration of the context, the function module 207 may update the context of the UE 101 at various services 109, such as social networking services, on behalf of the UE 101a. By way of a specific example, a user may purchase a ticket for a cruise using a credit card or debit card at a travel agent. A proxy device 117a associated with the travel agent may provide the information associated with the transaction to the context duration platform 103 such that the context duration platform 103 may then determine the context of the user (e.g., on a cruise ship) and predict duration of the context (e.g., the length of time of the cruise). Without requesting or receiving context information from a UE 101a associated with the user, the context duration platform 103 may determine the context of the user and the predicted duration of the context. When the time comes for the cruise, the context duration platform 103, by way of the function module 207, may update one or more services 109 regarding the context of the user independently from accessing the UE 101a to determine the context information associated with the UE 101a. Additionally, during the predicted duration of the context, the context duration platform 103 may update the location of the UE 101a by interfacing with, for example, the service provider associated with the cruise to determine the location of the cruise ship rather than attempting to contact the UE 101a directly, which may otherwise require extensive resources or communications off of home networks.

In one embodiment, the context duration platform 103 includes an update module 209. The update module 209 may be used to determine the accuracy of the context module 203 and the duration module 205. Upon the context module 203 determining and/or predicting the context of a UE 101a, the update module 209 may schedule one or more requests for context information from the UE 101a to determine the accuracy of the context determination. For example, if the context module 203 predicted a location of the UE 101a, the update module 209 may determine the actual location of the UE 101a at some point after the prediction of the location. Similarly, upon the duration module 205 predicting a duration of a context of a UE 101a, the update module 209 may schedule one or more requests for context information from the UE 101a to determine the accuracy of the predicted duration. Based on the updates, the update module 209 may interface with one or more of the context module 203 and the duration module 205 to update the methods used to determine and/or predict the context and predict the duration of the context.

For example, if one or more prediction modules generated based on training data associated with a UE 101a were used to determine a predicted duration, the update module 209 may cause the prediction models to be updated with the subsequently determined context information that may indicate a different duration of the context. The update module 209 may also be used to refine one or more attributes associated with one or more proxy devices 117 that determine one or more impacts to contexts and predicted durations of UE 101. If the predicted duration of a context was instead determined based on an attribute associated with a proxy device 117a, the update module 209 may update the attribute associated with the proxy device 117a to more accurately determine the predicted duration of a context.

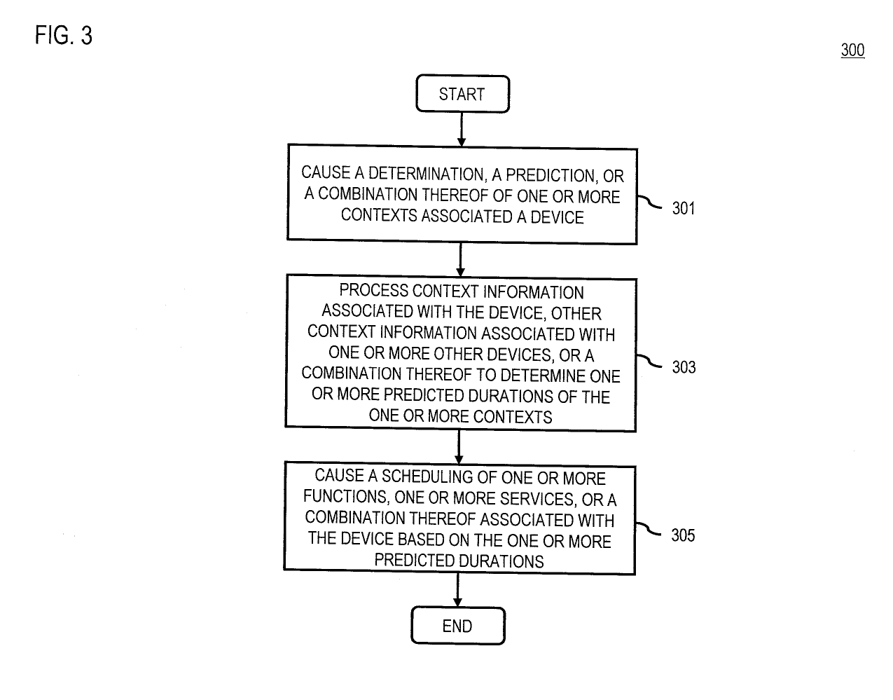

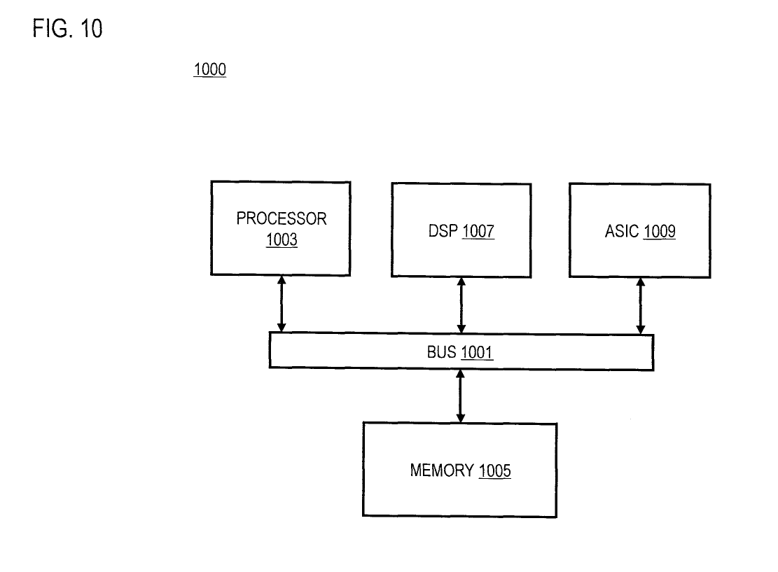

FIG. 3 is a flowchart of a process for determining a predicted duration of a context, according to one embodiment. In one embodiment, the context duration platform 103 performs the process 300 and is implemented in, for instance, a chip set including a processor and a memory as shown in FIG. 10. In step 301, the context duration platform 103 causes, at least in part, a determination, a prediction, or a combination thereof of one or more contexts associated with a device. The determination of the context may be based on context information associated with the device, other context information associated with one or more other devices, or a combination thereof. For example, the context duration platform 103 may determine the current location of a UE 101a and determine that the location has remained constant for the past half hour. Accordingly, the context of the user is the determined location. If the location is specific enough, such as the bedroom of the user's house, and time is also determined as part of the context information, such as 3:00 AM, the context duration platform 103 can determine that the user is in the context of being asleep at home. The prediction of the context may be based on other context information associated with one or more other devices. By way of example, the context information of the device may include information regarding a navigational application 111 that is currently active with a route to an intended destination. Based on the intended destination, the context duration platform 103 may determine the predicted context of the user associated with the device is the intended destination. Moreover, if the context duration platform 103 determines there is an active navigation route associated with a navigational application 111, but there is no specified destination associated with the route, the context duration platform 103 may determine a predicted destination, and therefore a predicted context of the user, based on one or more other devices that have traveled along the same route. For instance, a route may be common to multiple users if the route is associated with some form of mass transportation (e.g., bus, train, plane, etc.). The predicted context may be the predicted destination of the route based on the other users using the predicted destination as their destinations.

In step 303, the context duration platform 103 processes context information associated with the device, other context information associated with one or more other devices, or a combination thereof to determine one or more predicted durations of the one or more contexts. In one embodiment, the context duration platform 103 determines to perform a semantic analysis on the one or more contexts and determines the one or more predicted durations based, at least in part, on the semantic analysis. By way of example, where the context is associated with a location, the semantic analysis may be based on the location, such as based on geographical information associated with the location. Such geographical information may pertain to a point of interest near the location, the popularity of the location, or whether there is a landmark near the location. Such factors may be used to predict the duration of the context. For example, if there is a point of interest near the location, there may be a greater likelihood of remaining at the location for a period of time, thus affecting the predicted duration. The semantic analysis may be based on one or more words or terms associated with the location. The semantic analysis, for a location, may also be based on coordinates associated with the location.

As discussed above, the prediction may be based on one or more prediction models that consider the historical context information associated with the device, other context information associated with one or more other devices, or a combination thereof. If a user has a history of a duration associated with determined context information or a determined context, the context duration platform 103 may use one or more prediction models to determine such a relationship and determine the predicted duration accordingly. Moreover, if the user associated with a device does not have a duration associated with determined context information or a determined context, but other users to have such a duration based on historical context information associated with the other users, the context duration platform 103 may use one or more prediction models to determine such a relationship based on the other users and determine a predicted duration accordingly. Further, as discussed in more detail below, and as discussed above, one or more devices may have interact with one or more proxy devices 117. The interactions with the proxy devices 117 may be associated with context information that may be used to determine the predicted durations of one or more contexts.

In one embodiment, in step 305, the context duration platform 103 further causes, at least in part, a scheduling of one or more functions, one or more services, or a combination thereof associated with the device based, at least in part, on the one or more predicted durations. The context duration platform 103 may control the functionality of the UE 101 based on the predicted durations to provide more optimal resource optimization. The context duration platform 103 may also interface with one or more services 109 to perform one or more functions and or services on behalf of one or more UE 101. By way of example, the context duration platform 103 may update the context associated with the UE 101 at one or more social networking services 109 on behalf of the UE 101. The context duration platform 103 may also, for example, cause the UE 101 to enter airplane mode for a predicted duration if the UE 101 is detected as being on an airplane. Accordingly, the context duration platform 103 may provide resource optimization while maintaining the same level of information exchange associated with the user of the device.

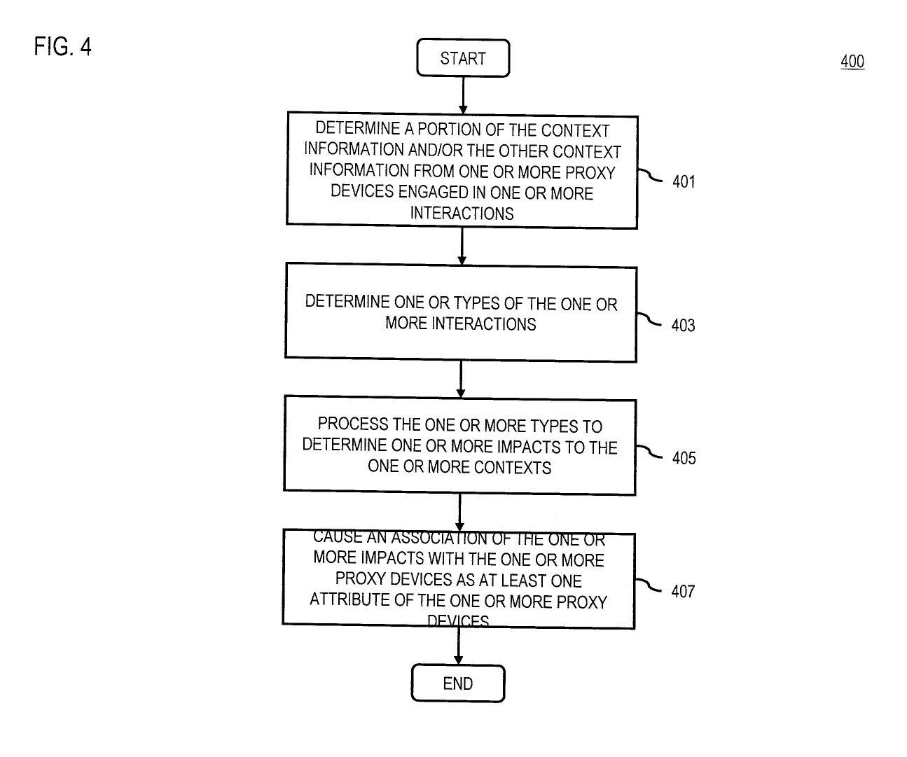

FIG. 4 is a flowchart of a process for determining context information for determining a predicted duration of a context, according to one embodiment. In one embodiment, the context duration platform 103 performs the process 400 and is implemented in, for instance, a chip set including a processor and a memory as shown in FIG. 10. In step 401, the context duration platform 103 determines at least a portion of the context information, the other context information, or a combination thereof from one or more proxy devices 117 engaged in one or more interactions associated with the device, the one or more other devices, or a combination thereof. By way of example, and as discussed above, a proxy device 117a may interact with a user during, for example, a transaction where an identifier is used by the user. For example, the user may make a purchase using a credit card or debit card. The user may also interact with a security system for entering a building by swiping a security identification card. The user may also pass through a toll plaza while traveling to a destination and the toll plaza may track the license plate of the car. Information associate with the credit card number, the security identification card or the license plate may be sent to the context duration platform 103 by the various systems associated with the interactions and used by the context duration platform 103 to identify the user. Subsequently, context information that is associated with the interactions may be used by the context duration platform 103 to, for example, determine one or more predicted durations of one or more contexts. The context information may include, for example, the store at which the user made the purchase, the date and time of the access using the security credentials, the location and time the user passed through the toll plaza, etc.

In step 403, the context duration platform 103 determines one or more types of the one or more interactions. The interactions may be in the form of any type of interaction, such as a transaction (e.g., a purchase of a good or service) and a type of a transaction (e.g., type of good and/or service), a security identification interaction, a login interaction, a checkpoint interaction (e.g., passing through a toll plaza), etc. Then, in step 405, the context duration platform 103 processes the one or more types of interactions to determine one or more impacts to the one or more contexts. Various interactions may have various impacts to the context and the predicted duration associated with the context. The impacts may be associated with whether the context will change, when the change may occur, etc. For example, the purchase of a meal at a restaurant will have the impact of maintaining the current location for a certain duration, the interaction with a security entry system will have the impact of, for example, going to work in the morning and maintaining the context of work for a certain duration, the interaction of buying a train ticket will have the impact of being on a train headed toward a destination and potentially inaccessible for a certain duration, etc. The context duration platform 103 may then determine the one or more predicted durations based, at least in part, on the one or more impacts.

In one embodiment, in step 407, the context duration platform 103 causes, at least in part, an association of the one or more impacts with the one or more proxy devices 117 as at least one attribute of the one or more proxy devices. The at least one attribute may indicate the impact on the context and/or the duration of the context. Accordingly, the context duration platform 103 may associate the at least one attribute of another device (e.g., a proxy device 117a) with one or more other devices (e.g., UE 101) that interact with the proxy device 117a. By way of example, after a proxy device 117a is associated with one or more transactions that are processed by the context duration platform 103, the context duration platform 103 may assign one or more attributes to the proxy device 117a that may be processed to determine the effects on the context and determined predicted duration of the context for one or more devices that interact with the proxy device 117a.

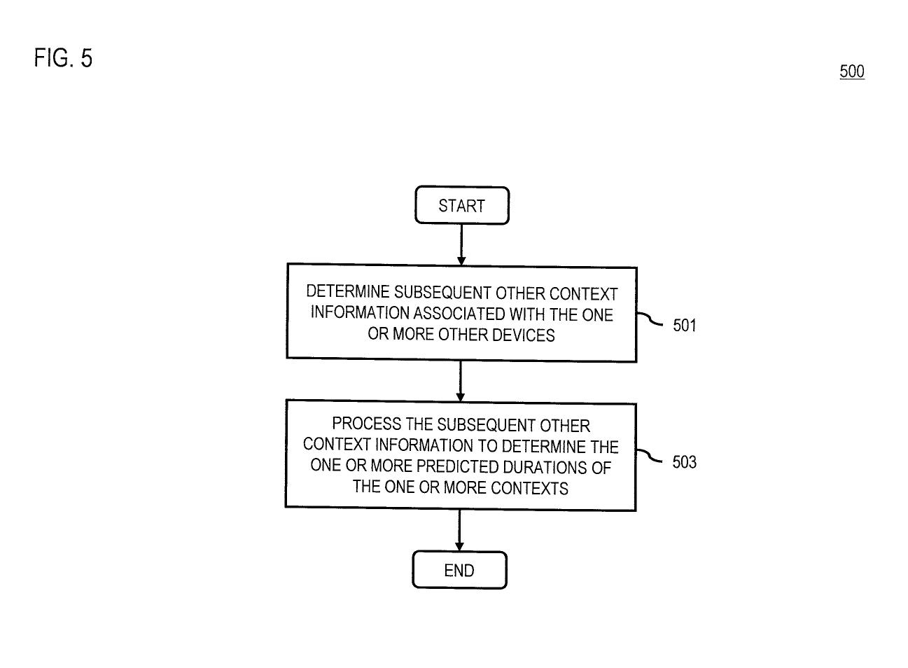

FIG. 5 is a flowchart of a process for determining a predicted duration of a context based on subsequent other context information from one or more other devices, according to one embodiment. In one embodiment, the context duration platform 103 performs the process 500 and is implemented in, for instance, a chip set including a processor and a memory as shown in FIG. 10. In step 501, the context duration platform 103 determines subsequent other context information associated with the one or more other devices. The subsequent other context information is context information that is generated by the one or more other devices subsequent to the one or more other devices interacting with one or more proxy devices 117. The subsequent other context information may be context information that is generated by, for example, one or more UE 101 after the UE 101 have interacted with a proxy device 117a. Particularly, the one or more UE 101 may have interacted with a proxy device 117a. In step 501, the context duration platform 103 determines the subsequent context information associated with the UE 101 that may reveal information regarding the actual context subsequent to the interaction. The context duration platform 103 may determine the subsequent context information of the one or more UE 101 at various intervals after the interaction to determine the full impact to the context of the UE 101 and the duration of the context of the UE 101.

In step 503, the context duration platform 103 processes the subsequent other context information to determine the one or more predicted durations of the one or more contexts. Based on the subsequent context information collected in step 501, the context duration platform 103 may update the one or more prediction models used for determining one or more predicted durations. In other words, the context duration platform 103 may refine the prediction models to more accurately reflect the duration of contexts based on the subsequent context information. Thus, the process 500 is an approach for adapting the context duration platform 103 and the methods used by the context duration platform 103 to determine more accurate predicted durations based on context information, and particularly context information associated with one or more proxy devices 117. The process 500 may be based on a crowd sourcing approach by determining the subsequent context information of multiple UE 101 to better determine the effects of the interactions. In one embodiment, rather than focusing on subsequent context information, the context duration platform 103 may determine historical context information associated with the UE 101 and process the historical context information and provide the processed information to service providers associated with the proxy devices 117 so that the service providers can understand the context of, for example, potential customers of the services offered by the service provider prior to the customers interacting with the proxy devices 117 associated with the services providers. This provides an incentive for the service providers to offer context information to the context duration platform 103 for determining predictive durations of contexts of users.

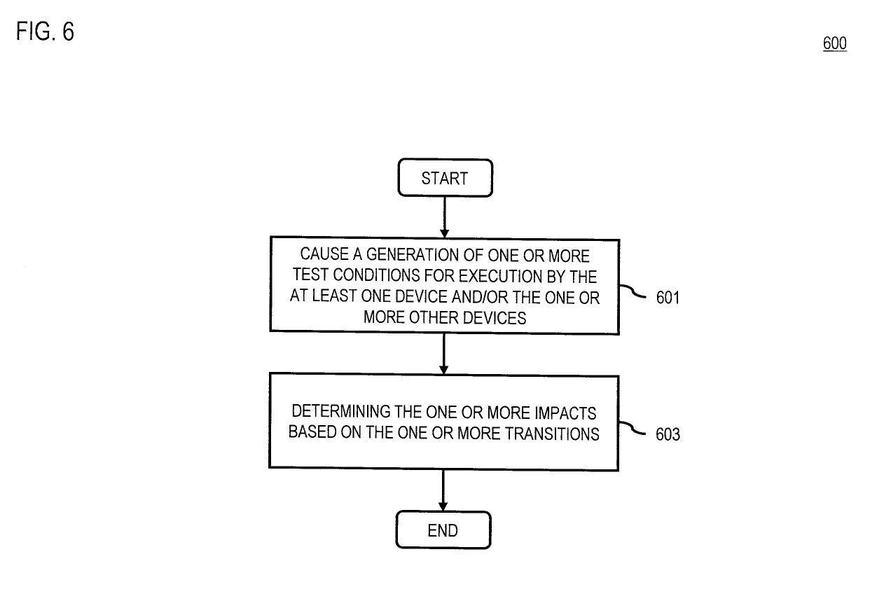

FIG. 6 is a flowchart of a process for testing the predicted durations, according to one embodiment. In one embodiment, the context duration platform 103 performs the process 600 and is implemented in, for instance, a chip set including a processor and a memory as shown in FIG. 10. In step 601, the context duration platform 103 causes, at least in part, a generation of one or more test conditions for execution by the at least one device, the one or more other devices, or a combination thereof. The one or more test conditions facilitate a determination of one or more transitions from the one or more contexts to one or more other contexts. The test conditions may be based on a determination of context information or a detection of changes in context information. By way of example, a test condition may be a condition to monitor for changes in a location and/or an activity.

In step 603, the context duration platform 103 determines one or more impacts based, at least in part, on the one or more transitions. In one embodiment, the context duration platform 103 may determine on or more impacts based on the test conditions. The impacts indicate, for example, the change in the context of the UE 101. By determining the transitions, the actual change of the context may be determined and used to refine impacts associated with one or more proxy devices 117 for determining one or more predicted durations. Thus, the process 600 is an approach for adapting the context duration platform 103 and the methods used by the context duration platform 103 to determine more accurate impacts, and therefore, predicted durations based on context information, and particularly context information associated with one or more proxy devices 117.

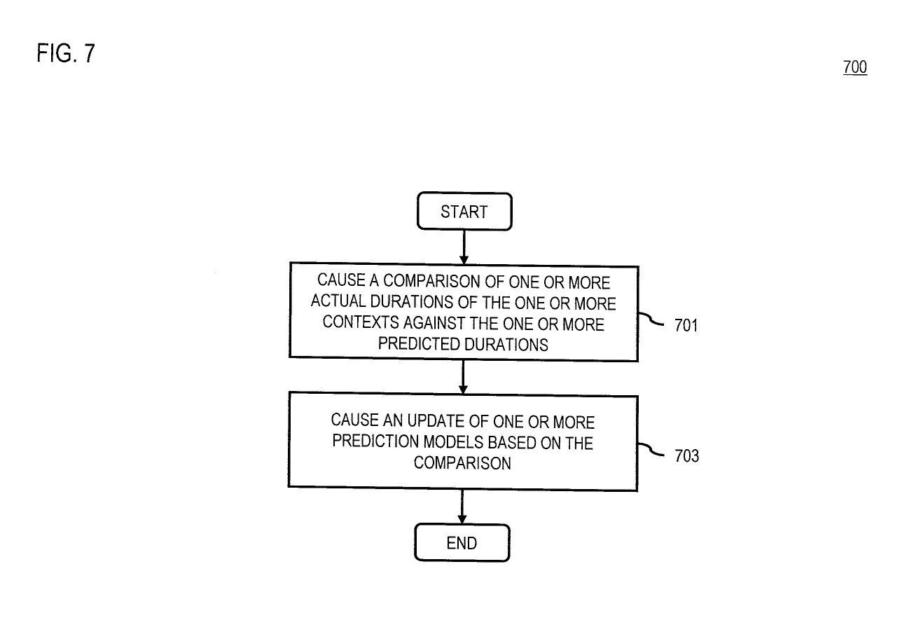

FIG. 7 is a flowchart of a process for adapting one or more prediction models to determine a predicted duration, according to one embodiment. In one embodiment, the context duration platform 103 performs the process 700 and is implemented in, for instance, a chip set including a processor and a memory as shown in FIG. 10. In step 701, the context duration platform 103 causes, at least in part, a comparison of one or more actual durations of the one or more contexts against the one or more predicted durations of a UE 101a that was associated with a determination of a predicted duration. The actual durations may be determined based on, for example, the context duration platform 103 initiating a request for context information associated with a UE 101a after the context duration platform 103 previously determined a predicted duration of a context. In one embodiment, the context duration platform 103 may have determined the predicted duration based on context information associated with the UE 101a. In one embodiment, the context duration platform 103 may have instead determined the predicted duration based on context information of one or more other UE 101 where there was not enough historical information associated with the UE 101. In one embodiment, the context duration platform 103 may have determined the predicted duration based on context information associated with an interaction between the UE 101a and one or more other proxy devices 117.

In step 703, the context duration platform 103 causes, at least in part, an update of one or more prediction models based, at least in part, on the comparison. As discussed above, the one or more prediction models are for determining the one or more predicted durations, one or more subsequent predicted durations, or a combination thereof. The prediction models may be based on, for example, the context information of the UE 101a and/or the other context information associated with one or more other UE 101. The one or more predicted durations may have been determined based on one or more prediction models based on a set of context information used as training data. The context information may have been based solely on context information associated with a single UE 101a. By determining the actual duration of a context, the context duration platform 103 may modify or adapt one or more prediction models that are trained based on context information. For example, the actual durations may be included in the set of context information used to train the prediction models. Where the one or more predicted durations were determined based on or more predictions models based on a set of context information from a group of users, actual durations associated with the groups of users may be determined to train the prediction models. The prediction models may then be used for any one or more all of the users after being adapted based on the actual durations. By updating the prediction models based on a comparison of a group of actual durations with respect to a group of predicted durations, the dataset is larger and may more accurately of quickly update the prediction models to provide more actuate predicted durations based on similar context information in the future.

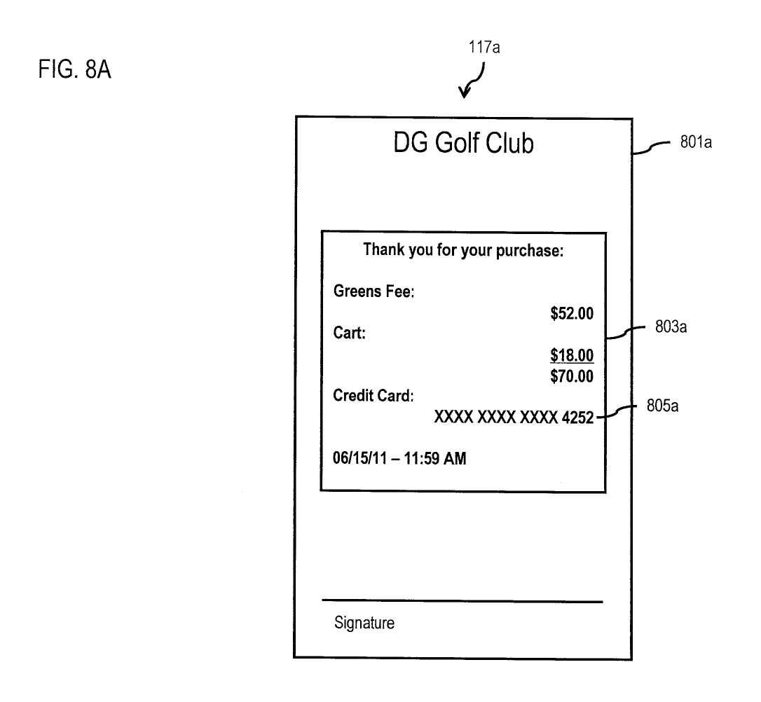

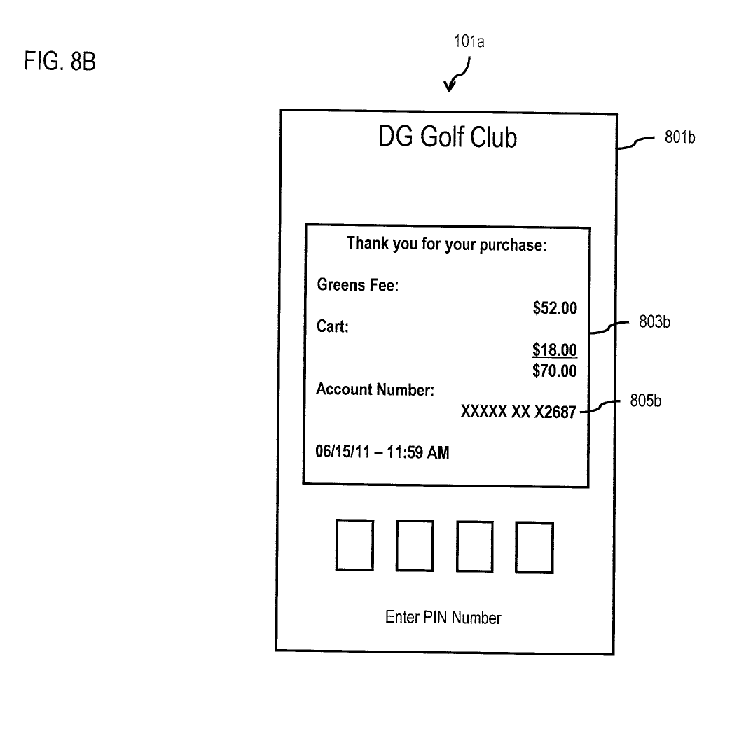

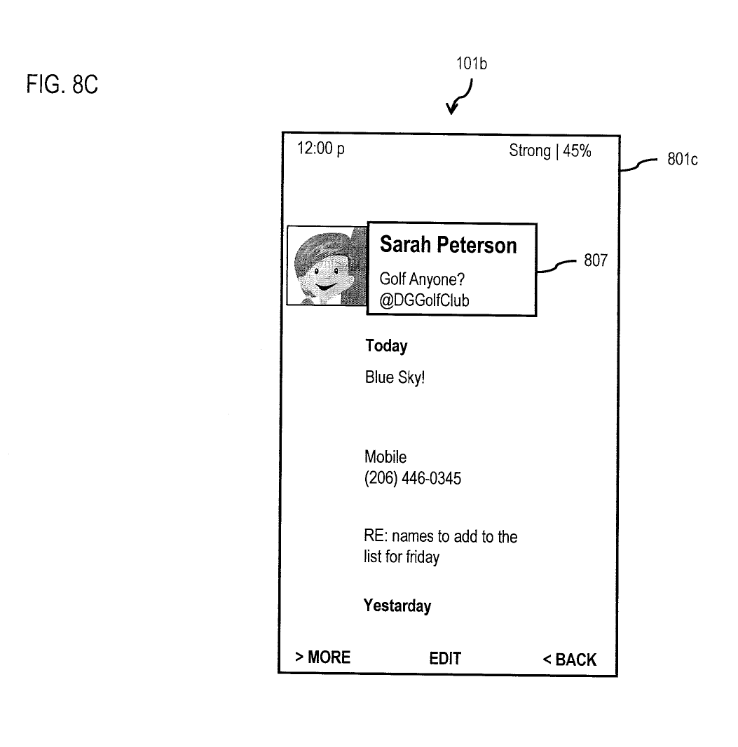

FIGS. 8A-8C are diagrams of user interfaces utilized in the processes of FIGS. 3-7, according to various embodiments. FIG. 8A illustrates an exemplary user interface 801a associated with a proxy device 117a that is involved in an interaction with a user. The interaction may include context information provided in a summary 803a in the user interface 801a. The summary 803a may include context information, such as the date of the interaction (e.g., Jun. 15, 2011), the time of the interaction (e.g., 11:59 AM) and an amount associated with the interaction (e.g., $70.00). The summary may also include an identifier 805a that may be sent to the context duration platform 103 from the system associated with the proxy device 117a that interacted with the user. By way of example, the transaction system associated with the proxy device 117a may forward the identifier 805a to the context duration platform 103, which may then correlate the identifier 805a to a user and subsequently determine and/or predict the context of the user, and also determine a predicted duration associated with the context. For example, the context may be playing golf and the predicted duration may be the average length it takes the user associated with the transaction to play a round of golf. In one embodiment, for example where the user does not have enough historical information to determine a predicted duration (e.g., first time the user has played golf, first time at the specific course, etc.), the context duration platform 103 may instead base the determination of the predicted duration on the average time it has taken other users to play golf at the golf course. In one embodiment, the context duration platform 103 may determine the transaction type is playing golf and determine that the proxy device 117a is associated with an attribute based on the average time required to play a game of golf.

FIG. 8B illustrates an exemplary user interface 801b associated with a UE 101a. The user interface 801b may be associated with a UE 101a when the UE 101a participates in a transaction, such as if the UE 101a has NFC capabilities and is used to make a purchase. The user interface 801b may have a similar summary 803b that provides the user with similar context information as the summary 803a in FIG. 8A. However, the summary 803b may include a different identifier, such as the identifier 805b that links the transaction to the UE 101a and the user of the UE 101a based on, for example, an account number associated with the NFC capabilities of the UE 101a. Thus, based on the similar identifier discussed with respect to FIG. 8A, the identifier 805b may be used to link the user to the transaction and the context duration platform 103 may determine and/or predict the context of the user, and may determine a predicted duration associated with the context.

FIG. 8C illustrates an exemplary user interface 801c associated with another UE 101b as compared to the UE 101a illustrated in FIG. 8B. For example, the UE 101b may be associated with a friend of the user of the UE 101a. The friend and the user may belong to the same social networking service. The user interface 801c may be associated with the social networking interface, specifically of a profile page associated with the user of the UE 101a. The user interface 801c may include an indicator 807 that is generated based on the context duration platform 103 according to the context information associated with either one or both of the summaries 803a and 803b. By way of example, the indicator 807 broadcasts the context of the user associated with the UE 101a as “Golf Anyone?@DGGolfClub” based on the user being associated with the context of playing golf. Thus, the context duration platform 103 may update context information on behalf of the user associated with the UE 101a without the user of the UE 101a performing any action. Accordingly, the resources that would have been otherwise required to update the context may be saved for other tasks. In one embodiment, the indicator 807 may also include the determined predicted duration to let other users know when the user will be available.

The processes described herein for determining a predicted duration of a context may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

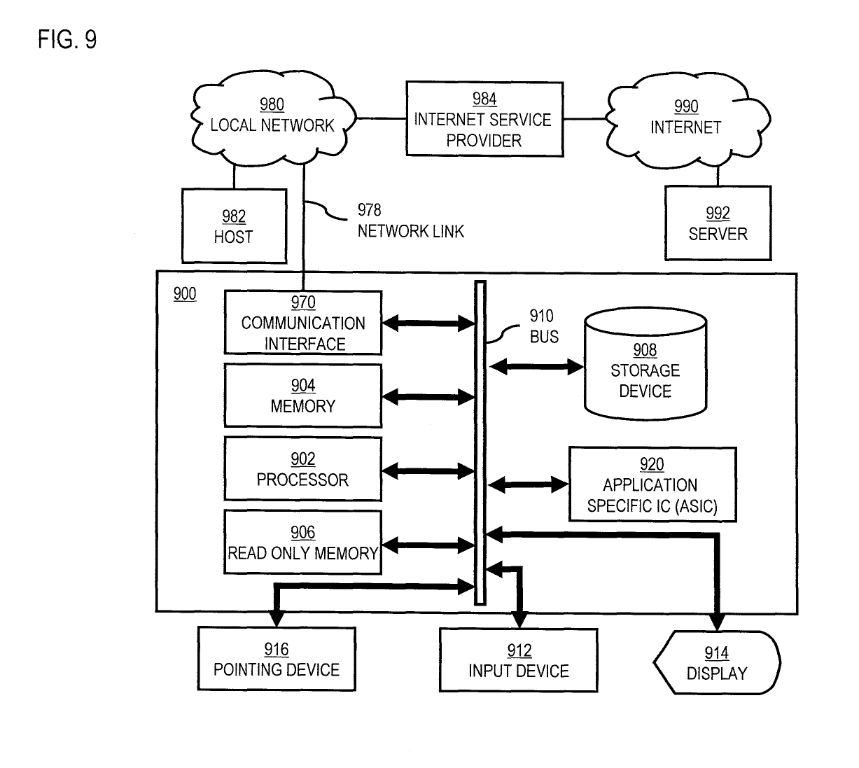

FIG. 9 illustrates a computer system 900 upon which an embodiment of the invention may be implemented. Although computer system 900 is depicted with respect to a particular device or equipment, it is contemplated that other devices or equipment (e.g., network elements, servers, etc.) within FIG. 9 can deploy the illustrated hardware and components of system 900. Computer system 900 is programmed (e.g., via computer program code or instructions) to determine a predicted duration of a context as described herein and includes a communication mechanism such as a bus 910 for passing information between other internal and external components of the computer system 900. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 900, or a portion thereof, constitutes a means for performing one or more steps of determining a predicted duration of a context.

A bus 910 includes one or more parallel conductors of information so that information is transferred quickly among devices coupled to the bus 910. One or more processors 902 for processing information are coupled with the bus 910.

A processor (or multiple processors) 902 performs a set of operations on information as specified by computer program code related to determining a predicted duration of a context. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 910 and placing information on the bus 910. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 902, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 900 also includes a memory 904 coupled to bus 910. The memory 904, such as a random access memory (RAM) or any other dynamic storage device, stores information including processor instructions for determining a predicted duration of a context. Dynamic memory allows information stored therein to be changed by the computer system 900. RAM allows a unit of information stored at a location called a memory address to be stored and retrieved independently of information at neighboring addresses. The memory 904 is also used by the processor 902 to store temporary values during execution of processor instructions. The computer system 900 also includes a read only memory (ROM) 906 or any other static storage device coupled to the bus 910 for storing static information, including instructions, that is not changed by the computer system 900. Some memory is composed of volatile storage that loses the information stored thereon when power is lost. Also coupled to bus 910 is a non-volatile (persistent) storage device 908, such as a magnetic disk, optical disk or flash card, for storing information, including instructions, that persists even when the computer system 900 is turned off or otherwise loses power.

Information, including instructions for determining a predicted duration of a context, is provided to the bus 910 for use by the processor from an external input device 912, such as a keyboard containing alphanumeric keys operated by a human user, a microphone, an Infrared (IR) remote control, a joystick, a game pad, a stylus pen, a touch screen, or a sensor. A sensor detects conditions in its vicinity and transforms those detections into physical expression compatible with the measurable phenomenon used to represent information in computer system 900. Other external devices coupled to bus 910, used primarily for interacting with humans, include a display device 914, such as a cathode ray tube (CRT), a liquid crystal display (LCD), a light emitting diode (LED) display, an organic LED (OLED) display, a plasma screen, or a printer for presenting text or images, and a pointing device 916, such as a mouse, a trackball, cursor direction keys, or a motion sensor, for controlling a position of a small cursor image presented on the display 914 and issuing commands associated with graphical elements presented on the display 914. In some embodiments, for example, in embodiments in which the computer system 900 performs all functions automatically without human input, one or more of external input device 912, display device 914 and pointing device 916 is omitted.

In the illustrated embodiment, special purpose hardware, such as an application specific integrated circuit (ASIC) 920, is coupled to bus 910. The special purpose hardware is configured to perform operations not performed by processor 902 quickly enough for special purposes. Examples of ASICs include graphics accelerator cards for generating images for display 914, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 900 also includes one or more instances of a communications interface 970 coupled to bus 910. Communication interface 970 provides a one-way or two-way communication coupling to a variety of external devices that operate with their own processors, such as printers, scanners and external disks. In general the coupling is with a network link 978 that is connected to a local network 980 to which a variety of external devices with their own processors are connected. For example, communication interface 970 may be a parallel port or a serial port or a universal serial bus (USB) port on a personal computer. In some embodiments, communications interface 970 is an integrated services digital network (ISDN) card or a digital subscriber line (DSL) card or a telephone modem that provides an information communication connection to a corresponding type of telephone line. In some embodiments, a communication interface 970 is a cable modem that converts signals on bus 910 into signals for a communication connection over a coaxial cable or into optical signals for a communication connection over a fiber optic cable. As another example, communications interface 970 may be a local area network (LAN) card to provide a data communication connection to a compatible LAN, such as Ethernet. Wireless links may also be implemented. For wireless links, the communications interface 970 sends or receives or both sends and receives electrical, acoustic or electromagnetic signals, including infrared and optical signals, that carry information streams, such as digital data. For example, in wireless handheld devices, such as mobile telephones like cell phones, the communications interface 970 includes a radio band electromagnetic transmitter and receiver called a radio transceiver. In certain embodiments, the communications interface 970 enables connection to the communication network 105 for determining a predicted duration of a context of the UE 101.

The term “computer-readable medium” as used herein refers to any medium that participates in providing information to processor 902, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 908. Volatile media include, for example, dynamic memory 904. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 920.

Network link 978 typically provides information communication using transmission media through one or more networks to other devices that use or process the information. For example, network link 978 may provide a connection through local network 980 to a host computer 982 or to equipment 984 operated by an Internet Service Provider (ISP). ISP equipment 984 in turn provides data communication services through the public, world-wide packet-switching communication network of networks now commonly referred to as the Internet 990.

A computer called a server host 992 connected to the Internet hosts a process that provides a service in response to information received over the Internet. For example, server host 992 hosts a process that provides information representing video data for presentation at display 914. It is contemplated that the components of system 900 can be deployed in various configurations within other computer systems, e.g., host 982 and server 992.

At least some embodiments of the invention are related to the use of computer system 900 for implementing some or all of the techniques described herein. According to one embodiment of the invention, those techniques are performed by computer system 900 in response to processor 902 executing one or more sequences of one or more processor instructions contained in memory 904. Such instructions, also called computer instructions, software and program code, may be read into memory 904 from another computer-readable medium such as storage device 908 or network link 978. Execution of the sequences of instructions contained in memory 904 causes processor 902 to perform one or more of the method steps described herein. In alternative embodiments, hardware, such as ASIC 920, may be used in place of or in combination with software to implement the invention. Thus, embodiments of the invention are not limited to any specific combination of hardware and software, unless otherwise explicitly stated herein.

The signals transmitted over network link 978 and other networks through communications interface 970, carry information to and from computer system 900. Computer system 900 can send and receive information, including program code, through the networks 980, 990 among others, through network link 978 and communications interface 970. In an example using the Internet 990, a server host 992 transmits program code for a particular application, requested by a message sent from computer 900, through Internet 990, ISP equipment 984, local network 980 and communications interface 970. The received code may be executed by processor 902 as it is received, or may be stored in memory 904 or in storage device 908 or any other non-volatile storage for later execution, or both. In this manner, computer system 900 may obtain application program code in the form of signals on a carrier wave.

Various forms of computer readable media may be involved in carrying one or more sequence of instructions or data or both to processor 902 for execution. For example, instructions and data may initially be carried on a magnetic disk of a remote computer such as host 982. The remote computer loads the instructions and data into its dynamic memory and sends the instructions and data over a telephone line using a modem. A modem local to the computer system 900 receives the instructions and data on a telephone line and uses an infra-red transmitter to convert the instructions and data to a signal on an infra-red carrier wave serving as the network link 978. An infrared detector serving as communications interface 970 receives the instructions and data carried in the infrared signal and places information representing the instructions and data onto bus 910. Bus 910 carries the information to memory 904 from which processor 902 retrieves and executes the instructions using some of the data sent with the instructions. The instructions and data received in memory 904 may optionally be stored on storage device 908, either before or after execution by the processor 902.

FIG. 10 illustrates a chip set or chip 1000 upon which an embodiment of the invention may be implemented. Chip set 1000 is programmed to determine a predicted duration of a context as described herein and includes, for instance, the processor and memory components described with respect to FIG. 9 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 1000 can be implemented in a single chip. It is further contemplated that in certain embodiments the chip set or chip 1000 can be implemented as a single “system on a chip.” It is further contemplated that in certain embodiments a separate ASIC would not be used, for example, and that all relevant functions as disclosed herein would be performed by a processor or processors. Chip set or chip 1000, or a portion thereof, constitutes a means for performing one or more steps of providing user interface navigation information associated with the availability of functions. Chip set or chip 1000, or a portion thereof, constitutes a means for performing one or more steps of determining a predicted duration of a context.

In one embodiment, the chip set or chip 1000 includes a communication mechanism such as a bus 1001 for passing information among the components of the chip set 1000. A processor 1003 has connectivity to the bus 1001 to execute instructions and process information stored in, for example, a memory 1005. The processor 1003 may include one or more processing cores with each core configured to perform independently. A multi-core processor enables multiprocessing within a single physical package. Examples of a multi-core processor include two, four, eight, or greater numbers of processing cores. Alternatively or in addition, the processor 1003 may include one or more microprocessors configured in tandem via the bus 1001 to enable independent execution of instructions, pipelining, and multithreading. The processor 1003 may also be accompanied with one or more specialized components to perform certain processing functions and tasks such as one or more digital signal processors (DSP) 1007, or one or more application-specific integrated circuits (ASIC) 1009. A DSP 1007 typically is configured to process real-world signals (e.g., sound) in real time independently of the processor 1003. Similarly, an ASIC 1009 can be configured to performed specialized functions not easily performed by a more general purpose processor. Other specialized components to aid in performing the inventive functions described herein may include one or more field programmable gate arrays (FPGA), one or more controllers, or one or more other special-purpose computer chips.

In one embodiment, the chip set or chip 1000 includes merely one or more processors and some software and/or firmware supporting and/or relating to and/or for the one or more processors.

The processor 1003 and accompanying components have connectivity to the memory 1005 via the bus 1001. The memory 1005 includes both dynamic memory (e.g., RAM, magnetic disk, writable optical disk, etc.) and static memory (e.g., ROM, CD-ROM, etc.) for storing executable instructions that when executed perform the inventive steps described herein to determine a predicted duration of a context. The memory 1005 also stores the data associated with or generated by the execution of the inventive steps.

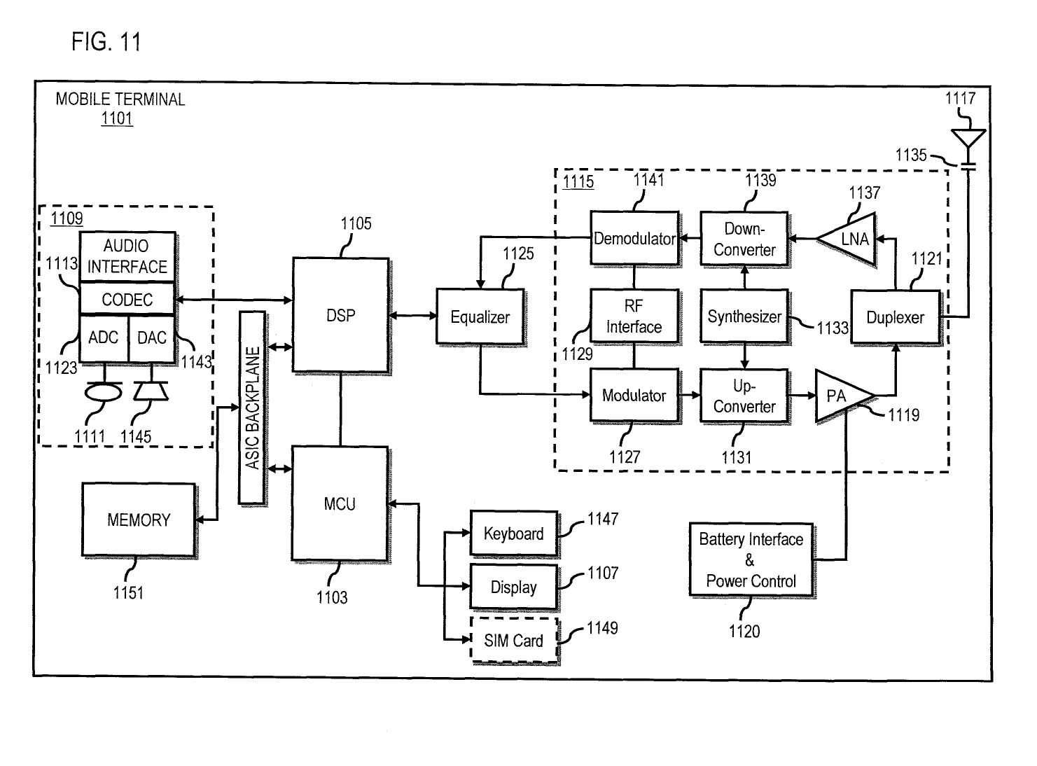

FIG. 11 is a diagram of exemplary components of a mobile terminal (e.g., handset) for communications, which is capable of operating in the system of FIG. 1, according to one embodiment. In some embodiments, mobile terminal 1101, or a portion thereof, constitutes a means for performing one or more steps of determining a predicted duration of a context. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 1103, a Digital Signal Processor (DSP) 1105, and a receiver/transmitter unit including a microphone gain control unit and a speaker gain control unit. A main display unit 1107 provides a display to the user in support of various applications and mobile terminal functions that perform or support the steps of determining a predicted duration of a context. The display 1107 includes display circuitry configured to display at least a portion of a user interface of the mobile terminal (e.g., mobile telephone). Additionally, the display 1107 and display circuitry are configured to facilitate user control of at least some functions of the mobile terminal. An audio function circuitry 1109 includes a microphone 1111 and microphone amplifier that amplifies the speech signal output from the microphone 1111. The amplified speech signal output from the microphone 1111 is fed to a coder/decoder (CODEC) 1113.

A radio section 1115 amplifies power and converts frequency in order to communicate with a base station, which is included in a mobile communication system, via antenna 1117. The power amplifier (PA) 1119 and the transmitter/modulation circuitry are operationally responsive to the MCU 1103, with an output from the PA 1119 coupled to the duplexer 1121 or circulator or antenna switch, as known in the art. The PA 1119 also couples to a battery interface and power control unit 1120.

In use, a user of mobile terminal 1101 speaks into the microphone 1111 and his or her voice along with any detected background noise is converted into an analog voltage. The analog voltage is then converted into a digital signal through the Analog to Digital Converter (ADC) 1123. The control unit 1103 routes the digital signal into the DSP 1105 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 1125 for compensation of any frequency-dependent impairments that occur during transmission though the air such as phase and amplitude distortion. After equalizing the bit stream, the modulator 1127 combines the signal with a RF signal generated in the RF interface 1129. The modulator 1127 generates a sine wave by way of frequency or phase modulation. In order to prepare the signal for transmission, an up-converter 1131 combines the sine wave output from the modulator 1127 with another sine wave generated by a synthesizer 1133 to achieve the desired frequency of transmission. The signal is then sent through a PA 1119 to increase the signal to an appropriate power level. In practical systems, the PA 1119 acts as a variable gain amplifier whose gain is controlled by the DSP 1105 from information received from a network base station. The signal is then filtered within the duplexer 1121 and optionally sent to an antenna coupler 1135 to match impedances to provide maximum power transfer. Finally, the signal is transmitted via antenna 1117 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 1101 are received via antenna 1117 and immediately amplified by a low noise amplifier (LNA) 1137. A down-converter 1139 lowers the carrier frequency while the demodulator 1141 strips away the RF leaving only a digital bit stream. The signal then goes through the equalizer 1125 and is processed by the DSP 1105. A Digital to Analog Converter (DAC) 1143 converts the signal and the resulting output is transmitted to the user through the speaker 1145, all under control of a Main Control Unit (MCU) 1103 which can be implemented as a Central Processing Unit (CPU).

The MCU 1103 receives various signals including input signals from the keyboard 1147. The keyboard 1147 and/or the MCU 1103 in combination with other user input components (e.g., the microphone 1111) comprise a user interface circuitry for managing user input. The MCU 1103 runs a user interface software to facilitate user control of at least some functions of the mobile terminal 1101 to determine a predicted duration of a context. The MCU 1103 also delivers a display command and a switch command to the display 1107 and to the speech output switching controller, respectively. Further, the MCU 1103 exchanges information with the DSP 1105 and can access an optionally incorporated SIM card 1149 and a memory 1151. In addition, the MCU 1103 executes various control functions required of the terminal. The DSP 1105 may, depending upon the implementation, perform any of a variety of conventional digital processing functions on the voice signals. Additionally, DSP 1105 determines the background noise level of the local environment from the signals detected by microphone 1111 and sets the gain of microphone 1111 to a level selected to compensate for the natural tendency of the user of the mobile terminal 1101.

The CODEC 1113 includes the ADC 1123 and DAC 1143. The memory 1151 stores various data including call incoming tone data and is capable of storing other data including music data received via, e.g., the global Internet. The software module could reside in RAM memory, flash memory, registers, or any other form of writable storage medium known in the art. The memory device 1151 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 1149 carries, for instance, important information, such as the cellular phone number, the carrier supplying service, subscription details, and security information. The SIM card 1149 serves primarily to identify the mobile terminal 1101 on a radio network. The card 1149 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1-38. (canceled)

39. A method comprising facilitating a processing of and/or processing (1) data and/or (2) information and/or (3) at least one signal, the (1) data and/or (2) information and/or (3) at least one signal based, at least in part, on the following:
a determination, a prediction, or a combination thereof of one or more contexts associated with at least one device; and
a processing of context information associated with the at least one device, other context information associated with one or more other devices, or a combination thereof to determine one or more predicted durations of the one or more contexts.

40. A method of claim 39, wherein the (1) data and/or (2) information and/or (3) at least one signal are further based, at least in part, on the following:
a scheduling of one or more functions, one or more services, or a combination thereof associated with the at least one device based, at least in part, on the one or more predicted durations.

41. A method of claim 39, wherein the (1) data and/or (2) information and/or (3) at least one signal are further based, at least in part, on the following:
at least one determination to perform a semantic analysis on the one or more contexts,
wherein the one or more predicted durations are further based, at least in part, on the semantic analysis.

42. A method of claim 39, wherein the (1) data and/or (2) information and/or (3) at least one signal are further based, at least in part, on the following:
a comparison of one or more actual durations of the one or more contexts against the one or more predicted durations; and
an update of one or more prediction models based, at least in part, on the comparison,
wherein the one or more prediction models are for determining the one or more predicted durations, one or more subsequent predicted durations, or a combination thereof.

43. A method of claim 39, wherein the (1) data and/or (2) information and/or (3) at least one signal are further based, at least in part, on the following:
at least one determination of at least a portion of the context information, the other context information, or a combination thereof from one or more proxy devices engaged in one or more interactions associated with the at least one device, the one or more other devices, or a combination thereof.

44. A method of claim 43, wherein the (1) data and/or (2) information and/or (3) at least one signal are further based, at least in part, on the following:
one or more types of the one or more interactions; and
a processing of the one or more types to determine one or more impacts to the one or more contexts,
wherein the one or more predicted durations are further based, at least in part, on the one or more impacts.

45. A method of claim 44, wherein the (1) data and/or (2) information and/or (3) at least one signal are further based, at least in part, on the following:
an association of the one or more impacts with the one or more proxy devices as at least one attribute of the one or more proxy devices.

46. A method of claim 44, wherein the (1) data and/or (2) information and/or (3) at least one signal are further based, at least in part, on the following:
subsequent other context information associated with the one or more other devices, the subsequent other context information being subsequent to the one or more interactions; and
a processing of the subsequent other context information to determine the one or more predicted durations of the one or more contexts.

47. A method of claim 44, wherein the (1) data and/or (2) information and/or (3) at least one signal are further based, at least in part, on the following:
a generation of one or more test conditions for execution by the at least one device, the one or more other devices, or a combination thereof, the one or more test conditions facilitating a determination of one or more transitions from the one or more contexts to one or more other contexts; and
at least one determination of the one or more impacts based, at least in part, on the one or more transitions.

48. A method of claim 39, wherein the one or more contexts include, at least in part, one or more locations, one or more activities, or a combination thereof, and the one or more predicted durations include, at least in part, include one or more predicted durations at the one or more locations, one or more predicted durations of the one or more activities, or a combination thereof, respectively.

49. An apparatus comprising:
at least one processor; and
at least one memory including computer program code for one or more programs,
the at least one memory and the computer program code configured to, with the at least one processor, cause the apparatus to perform at least the following,
cause, at least in part, a determination, a prediction, or a combination thereof of one or more contexts associated with at least one device; and
process and/or facilitate a processing of context information associated with the at least one device, other context information associated with one or more other devices, or a combination thereof to determine one or more predicted durations of the one or more contexts.

50. An apparatus of claim 49, wherein the apparatus is further caused to:
cause, at least in part, a scheduling of one or more functions, one or more services, or a combination thereof associated with the at least one device based, at least in part, on the one or more predicted durations.

51. An apparatus of claim 49, wherein the apparatus is further caused to:
determine to perform a semantic analysis on the one or more contexts,
wherein the one or more predicted durations are further based, at least in part, on the semantic analysis.

52. An apparatus of claim 49, wherein the apparatus is further caused to:
cause, at least in part, a comparison of one or more actual durations of the one or more contexts against the one or more predicted durations; and
cause, at least in part, an update of one or more prediction models based, at least in part, on the comparison,
wherein the one or more prediction models are for determining the one or more predicted durations, one or more subsequent predicted durations, or a combination thereof.

53. An apparatus of claim 49, wherein the apparatus is further caused to:
determine at least a portion of the context information, the other context information, or a combination thereof from one or more proxy devices engaged in one or more interactions associated with the at least one device, the one or more other devices, or a combination thereof.

54. An apparatus of claim 53, wherein the apparatus is further caused to:
determine one or more types of the one or more interactions; and
process and/or facilitate a processing of the one or more types to determine one or more impacts to the one or more contexts,
wherein the one or more predicted durations are further based, at least in part, on the one or more impacts.

55. An apparatus of claim 54, wherein the apparatus is further caused to:
cause, at least in part, an association of the one or more impacts with the one or more proxy devices as at least one attribute of the one or more proxy devices.

56. An apparatus of claim 54, wherein the apparatus is further caused to:
determine subsequent other context information associated with the one or more other devices, the subsequent other context information being subsequent to the one or more interactions; and
process and/or facilitate a processing of the subsequent other context information to determine the one or more predicted durations of the one or more contexts.

57. An apparatus of claim 54, wherein the apparatus is further caused to:
cause, at least in part, a generation of one or more test conditions for execution by the at least one device, the one or more other devices, or a combination thereof, the one or more test conditions facilitating a determination of one or more transitions from the one or more contexts to one or more other contexts; and
determine the one or more impacts based, at least in part, on the one or more transitions.

58. An apparatus of claim 54, wherein the one or more contexts include, at least in part, one or more locations, one or more activities, or a combination thereof, and the one or more predicted durations include, at least in part, include one or more predicted durations at the one or more locations, one or more predicted durations of the one or more activities, or a combination thereof, respectively.

59. A computer program product including one or more sequences of one or more instructions which, when executed by one or more processors, cause an apparatus to at least:
cause, at least in part, a determination, a prediction, or a combination thereof of one or more contexts associated with at least one device; and
process and/or facilitate a processing of context information associated with the at least one device, other context information associated with one or more other devices, or a combination thereof to determine one or more predicted durations of the one or more contexts.
